(19) United States
(12) Patent Application Publication
(10) Pub. No.: US 2001/0036218 A1
(43) Pub. Date: Nov. 1, 2001

(54) External resonator type laser light source

(76) Inventor: Seiji Funakawa, Kanagawa (JP)

Correspondence Address: Fish & Richardson P.C., 45 Rockefeller Plaza, Suite 2800, New York, NY, 10111, US

(21) Appl. No.: 09/844,118

(22) Filed: Apr. 27, 2001

(30) Foreign Application Priority Data
Apr. 27, 2000 (JP) P.2000-127911

(51) Int. Cl. H01S 3/08

(52) U.S. Cl. 372/102

(57) ABSTRACT

An external resonator type laser light source provides plural diffraction gratings GR1 and GR2. Outgoing light from the end surface (1) having the reflection reducing coating of the semiconductor laser comes in with diffraction angle α and light having wavelength λ goes out with diffraction angle β at a point A on diffraction surface of a first diffraction grating GR1, the light having wavelength λ going out from the first diffraction grating with diffraction angle β comes in with diffraction angle γ and goes out with diffraction angle γ at a point B on diffraction surface of a second diffraction grating GR2, the light returns to the semiconductor laser passing through the opposite direction light path of the second diffraction grating GR2, the first diffraction grating GR1, and the semiconductor laser, and an end surface of the opposite side to the end surface (1) having reflection reducing coating of the semiconductor laser and the second diffraction grating GR2 constructs the external resonator.

### BACKGROUND OF THE INVENTION

1. Field of the Invention

The present invention relates to an external resonator type laser light source used for optical communication.

2. Description of the Related Art

A light source capable of continuous changing of wavelength is actually used because wavelength of laser in an external resonator is always constant by Ritman-type wavelength tunable light source.

FIG. 9 shows an outline construction of the conventional external resonator type laser light source. Point A on diffraction surface of GR1, point B on reflecting surface of a mirror, and intersection point C of imaginary reflecting surface (2′) of end surface constructing external resonator of semiconductor laser assuming that all refractive indexes of components of the external resonator are 1 are positioned on the same circumference of radius r, an extended line of the imaginary reflecting surface (2′), an extended line of the diffraction surface of GR1, and an extended line of the reflecting surface of the mirror intersect at point O on the same circumference, and the mirror rotates round the point O.

As shown in the figure, in the conventional laser light source, reflection reducing coating is applied at one end surface (1) of the semiconductor laser LD, outgoing light from the end surface (1) of the reflection reducing coating side is converted to parallel light by a lens not shown, returned again to diffraction grating GR1 by the mirror after selecting wavelength of the parallel light, and returned to the semiconductor laser LD selecting again by the diffraction grating GR1 for laser oscillation.

In output light, outgoing light from the another end surface (2) of the semiconductor laser LD is converted to parallel light by a lens not shown, and concentrated to an optical fiber not shown by a lens not shown to be taken out after passing thorough a light isolator not shown.

Such the Ritman-type wavelength tunable light source (the external resonator type laser light source) of FIG. 9 is superior in wavelength selectivity because wavelength selection is carried out two times back-and-forth by the diffraction grating GR1, thereby is known as a kind of the most general system even now.

Thus, filtering effect of diffraction grating has promoted by two times diffraction using the mirror in the past.

However, in the external resonator type laser light source, there is a phenomenon (mode hop) that depressing effect of gain to longitudinal mode adjacent to longitudinal mode between the desired oscillation longitudinal mode and the adjacent longitudinal mode is small and the laser light source moves easy from the desired longitudinal mode to the adjacent another longitudinal mode by disturbance such as impact, temperature change and the like only because longitudinal mode spacing is narrow in wavelength filter effect of the conventional diffraction grating.

Further, in the case that enough depression does not effect to longitudinal mode having more than two filter conditions, laser oscillation is sometimes carried out with plural longitudinal modes (multi mode).

### SUMMARY OF THE INVENTION

Therefore, an object of the invention is to enhance filter effect of wavelength and depress unstable oscillation such as the multi mode oscillation and mode hop in the external resonator type laser light source.

To solve the above problems, as shown in FIG. 1, according to a first aspect of the invention, there is provided an external resonator type laser light source comprising a semiconductor laser LD having reflection reducing coating at one end surface (1) thereof, a diffraction grating GR as a wavelength selecting element, and plural diffraction gratings GR1 and GR2.

Here, the diffraction gratings may be more than 3.

According to the first aspect of the invention, since the external resonator type laser light source has plural diffraction gratings, and the second diffraction grating is used instead of mirror, it is possible to raise filter effect and depress unstable oscillation such as multi mode oscillation and hop up.

According to a second aspect of the invention, there is provided an external resonator type laser light according to the first aspect, wherein as shown in FIG. 1, outgoing light from the end surface (1) having the reflection reducing coating of the semiconductor laser comes with diffraction angle α and light having wavelength λ goes out with diffraction angle β at a point A on diffraction surface of a first diffraction grating GR1, the light having wavelength λ going out from the first diffraction grating GR1 with diffraction angle β comes in with diffraction angle γ and goes out with diffraction angle γ at a point B on diffraction surface of a second diffraction grating GR2, the light returns to the semiconductor laser passing through opposite direction light path of the second diffraction grating GR2, the first diffraction grating GR1, and the semiconductor laser, and

wherein an end surface of the opposite side to the end surface (1) having reflection reducing coating of the semiconductor laser and the second diffraction grating GR2 constructs the external resonator.

According to a third aspect of the invention, there is provided an external resonator type laser light source according to the second aspect, wherein, as shown in FIG. 1, the point A on diffraction surface of the first diffraction grating GR1, the point B on diffraction surface of the second diffraction grating GR2, and an intersection point C of imagined reflection surface (2′) of the end surface (2) constructing the external resonator of the semiconductor laser assuming that refractive indexes of all components in the external resonator are 1 are positioned on the same circumference of radius r, and an extended line of the imagined reflection surface (2′) and an extended line of diffraction surface of the first diffraction grating GR1 cross on the same circumference.

According to a fourth aspect of the invention, there is provided an external resonator type laser light source according to the second aspect, wherein, as shown in FIG. 1, laser oscillation is carried out with the same wavelength of diffraction wavelengths of the first diffraction grating GR1 and the second diffraction grating GR2 by rotating the second diffraction grating GR2 at any point O.

According to a fifth aspect of the invention, there is provided an external resonator type laser light source according to any one of claims 3 and 4, wherein, as shown in FIG. 1, an intersection point of an extended line of diffraction surface of the second diffraction grating GR2 at any wavelength λ1 and an extended line of diffraction surface of the second diffraction grating GR2-1 at another wavelength λ2 in a desired wavelength tuning range is a rotation center point O of the second diffraction grating GR2.

According to a sixth aspect of the invention, there is provided an external resonator type laser light source according to the fifth aspect, wherein, as shown in FIG. 1, phase of laser light in the external resonator is corrected when wavelength changed moving the second diffraction grating GR2 round rotation center point C by characteristic that phase delay of laser light within desired wavelength tuning range conflicts with shape of gain distribution of the semiconductor laser based on each numbers of grooves M1 and M2 of the first diffraction grating GR1 and the second diffracting grating GR2, incidence angle α from the semiconductor laser of the first diffraction grating GR1, the position of rotation center point O, and radius r.

According to a seventh aspect of the invention, there is provided an external resonator type laser light source according to the fifth aspect, wherein, as shown in FIGS. 6 and 8, a mechanism adjusting the position of rotation center point O of the second diffraction grating GR2, they are, an arm (11), apiezo element (14), a motor (12), a direct acting stage (13), and the like are provided.

According to an eighth aspect of the invention, there is provided an external resonator type laser light source according to the fifth aspect, wherein, as shown in FIGS. 7 and 8, a mechanism adjusting the position of diffraction surface of the second diffraction grating GR2, they are, an arm (11), a piezo element (14), a motor (12), a direct acting stage (13), and the like are provided.

### BRIEF DESCRIPTION OF THE DRAWINGS

FIG. 1 is an outline construction view showing an external resonator type laser light source according to a first aspect of the invention;

FIG. 2 is a view showing a position of diffraction surface of a second diffraction grating at wavelength tuning obtained by calculation and change of rotation center position by numbers of grooves of a first diffraction and the second diffraction;

FIG. 3 is a graph showing phase delay quantity of oscillation wavelength in a resonator;

FIG. 4 is a graph showing wavelength dependency of supplying current to a semiconductor laser;

FIG. 5 is a graph showing position change of center point O at wavelength tuning;

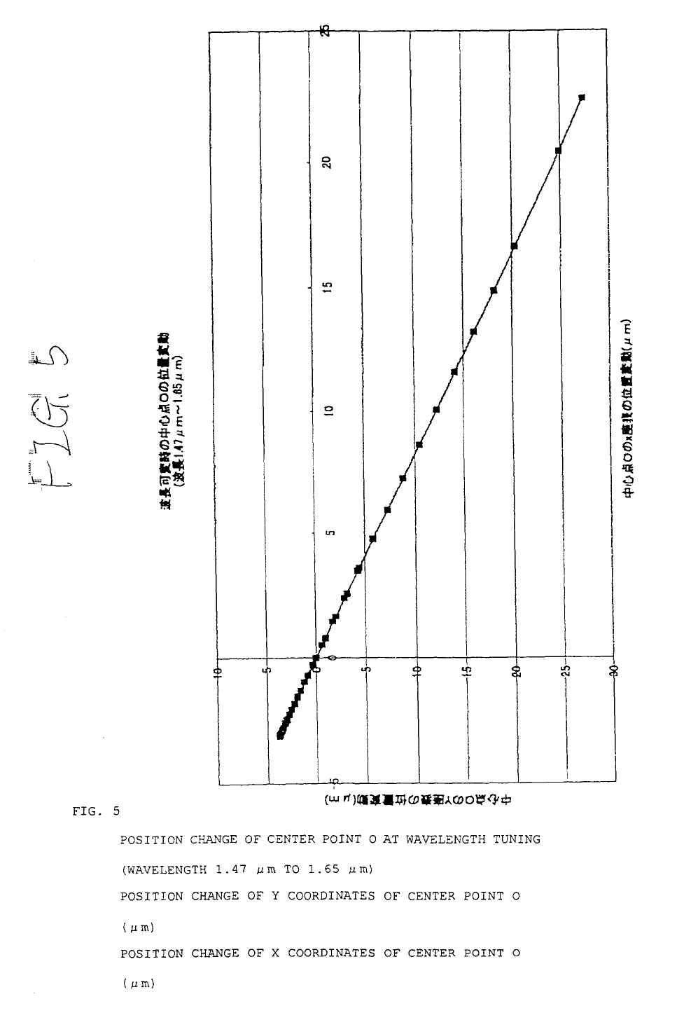

FIG. 6 is an outline construction view showing a main portion according to a second embodiment of the invention;

FIG. 7 is an outline construction view showing a main portion according to a third embodiment of the invention;

FIG. 8 is an outline construction view showing a main portion according to a fourth embodiment of the invention; and

FIG. 9 is the outline construction view showing the conventional external resonator type laser light source.

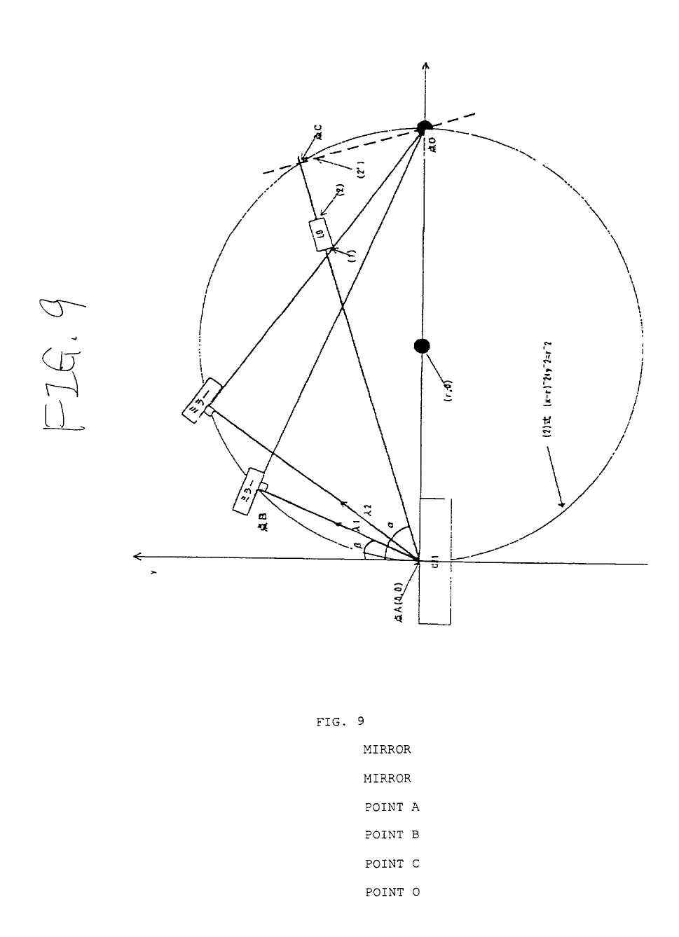

### DETAILED DESCRIPTION OF THE PREFERRED EMBODIMENTS

Preferred embodiments of the invention will be described with reference to the accompanying drawings.

### First Embodiment

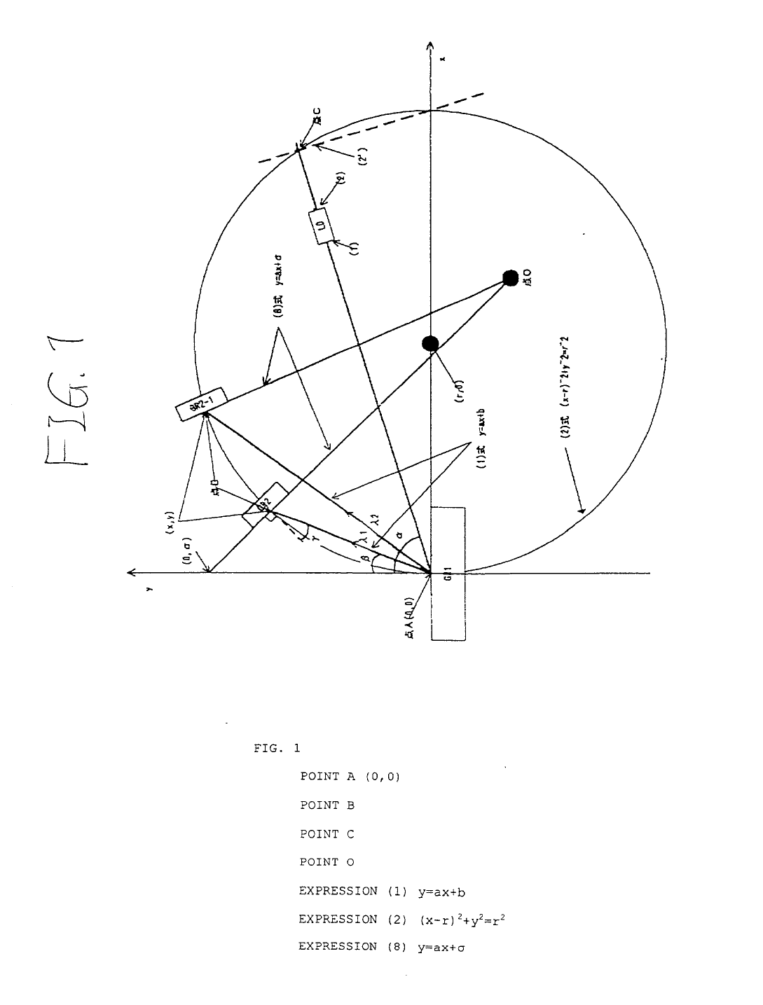

FIG. 1 is an outline construction view showing an external resonator type laser light source according to a first embodiment of the invention.

In FIG. 1, symbol LD is a semiconductor laser, symbol (1) shows an end surface having reflection reducing coating, symbol (2) shows an end surface facing to the end surface (1), and symbol (2′) shows imaged reflecting surface of the end surface (2) assuming that refractive index in the external resonator are all 1.

Symbol GR1 is a first diffraction grating, numbers of grooves is M1, and diffraction order is m1.

Symbol GR2 is a second diffraction grating, numbers of grooves is M2, and diffraction order is m2. The GR2 shows the diffraction grating when the external resonator laser light source laser-oscillates at λ1.

The GR2-1 shows the second diffraction grating when the external resonator laser light source laser-oscillates at λ2.

Points A,B, and C are points on a laser light path of GR1, GR2, and the end surface (2′) of LD, and also are intersection points with a circle centering a point (r, 0) as center point shown in expression (2).

Symbol α is incidence angle from the LD to GR1, symbol β is outgoing angle from GR1, and symbol γ is incidence and outgoing angle of GR2.

Expression of outgoing of laser light from GR1 is expressed with expression (1),

y=ax+b=(tan(π/2−β))x.

Diffraction grating at Ritman-type wavelength tunable laser, that is, circle standardizing laser resonation end surface, is expressed with expression (2),

(x−r)²+y²=r².

Expression of an extended line of diffraction surface of GR2 is expressed with expression (8),

y=ax+σ=[−tan(β+γ)]×(x+Bx)+By.

Next, expressions will be described.

Expression (1) is an expression of outgoing light calculated from the expression of diffraction of wavelength of diffraction grating.

First, from the expression concerned with incidence and outgoing angle of the diffraction grating,

sin(α)+sin(β)=m×M×λ (3)

β=sin⁻¹((m×M×λ)−sin(α)) (4)

By the expression, a slope a of outgoing light of the laser light is

A=tan(π/2−β) (5)

Since coordinates of the point A on GR1 is (0,0), b=0.

Therefore, an expression of outgoing light of GR1 is

y=(tan(π/2−β))x (1)

Expression (8) is an expression of extended line of diffraction surface of GR2.

First, by the equation of circle, an expression of standard circle at Ritman-type wavelength tunable laser is

(x−r)²+y²=r² (2)

An intersection point except coordinates (0,0) of expression (1) and expression (5) is

Bx−(2xr)/(1+(tan(π/2β))²) (6)

By=(tan(π/2−β))²)1×Bx (7)

Since α=β=γ, GR2 is from the expression (3)

λ=asin((m×M×λ)/2)

By the expression, an expression of diffraction surface GR2 is

Y=[−tan(β+γ)]×(x+Bx)+By (8)

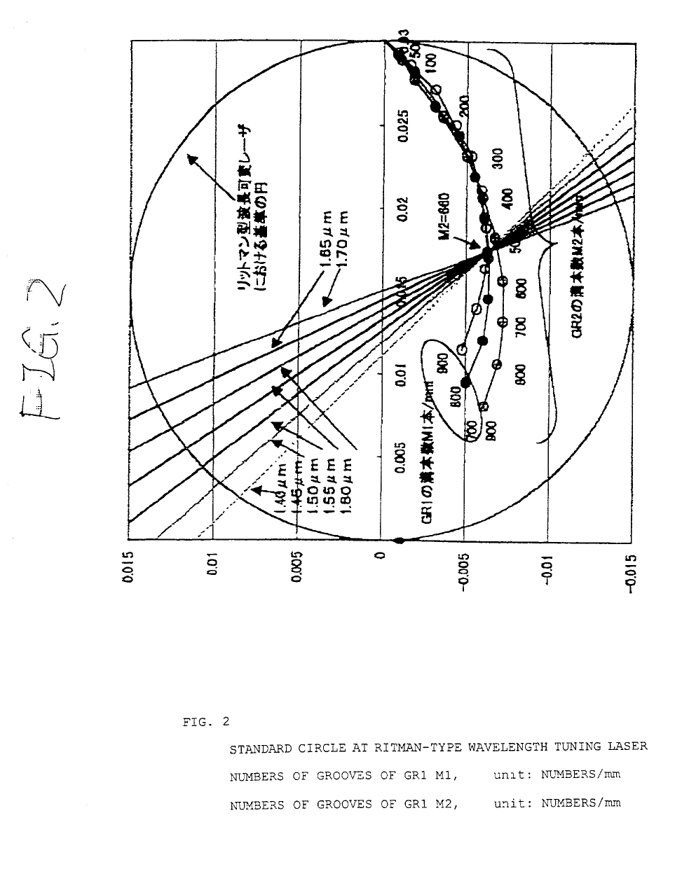

FIG. 2 shows positions of refraction surface of GR2 at wavelength tuning obtained by calculation (M1=900/mm, M2=660/mm) and change of center position of rotation by numbers of grooves of GR1 and GR2.

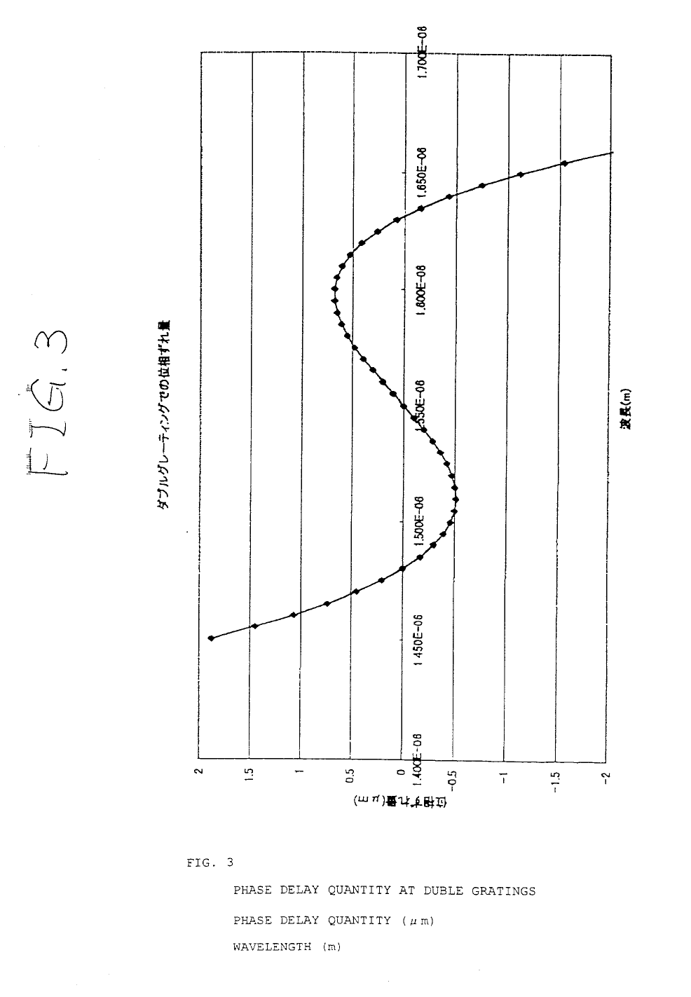

FIG. 3 shows phase delay quantity of oscillation wavelength in the resonator according to the above embodiment, and shows phase delay quantity of oscillation wavelength in the external resonator when GR2 is moved at the point O and wavelength is changed in the embodiment.

Although phase delay makes a cause to generate mode hop, phenomenon mode hop does not occur by draw-in effect of gain at the oscillation state as the external resonator laser in the embodiment.

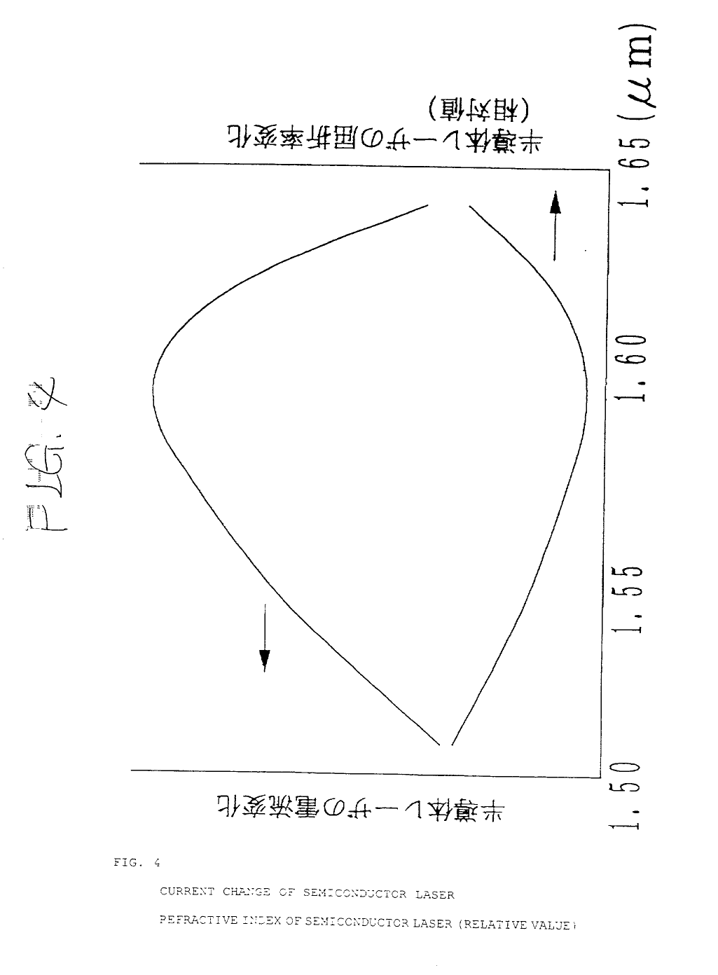

Current supplied to the semiconductor laser changes as FIG. 4 to keep light output of the external resonator laser constant. Because of that, refractive index in the semiconductor laser changes in inverse proportion to the change.

Because change of refractive index in the semiconductor laser operates so as to correct phase delay quantity of FIG. 3, phase delay quantity as the external resonator becomes smaller than FIG. 3.

### EXAMPLE

Range of wavelength tuning: 1470 nm to 1650 nm

GR1: M1=900/mm, m1=1, α=75 deg

GR2: M1=660/mm, m2=1

Radius of circle: r=0.015

Coordinates of point O: (0.01753, −0.00630), unit: m

Improved rate of wavelength selectivity by changing to GR2 from the mirror: about 1.7 times

### Second Embodiment

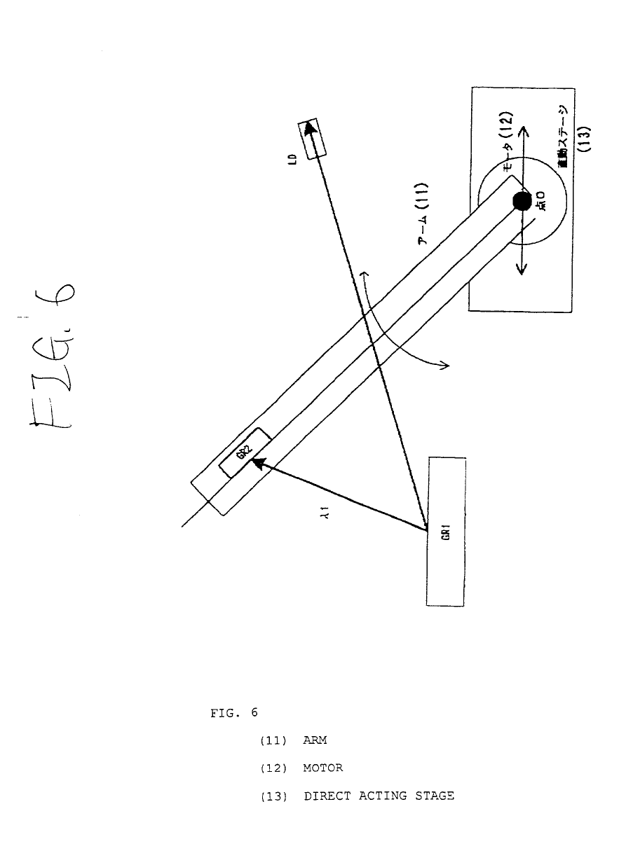

The embodiment of FIG. 6 has a differential mechanism of one shaft at a center point O of rotation and makes phase delay quantity as the external resonator minimum.

Control system is a table control system of wavelength vs. correcting position.

A motor (12) is used at rotation shaft of an arm (11) supporting GR2.

The motor (12) is installed on a direct acting stage (13). The direct acting stage (13) may be moved to vertical direction in the figure though it is moved to horizontal direction in the figure.

The differential mechanism is driven by attaching a piezo element not shown on the direct acting stage (13).

### Third Embodiment

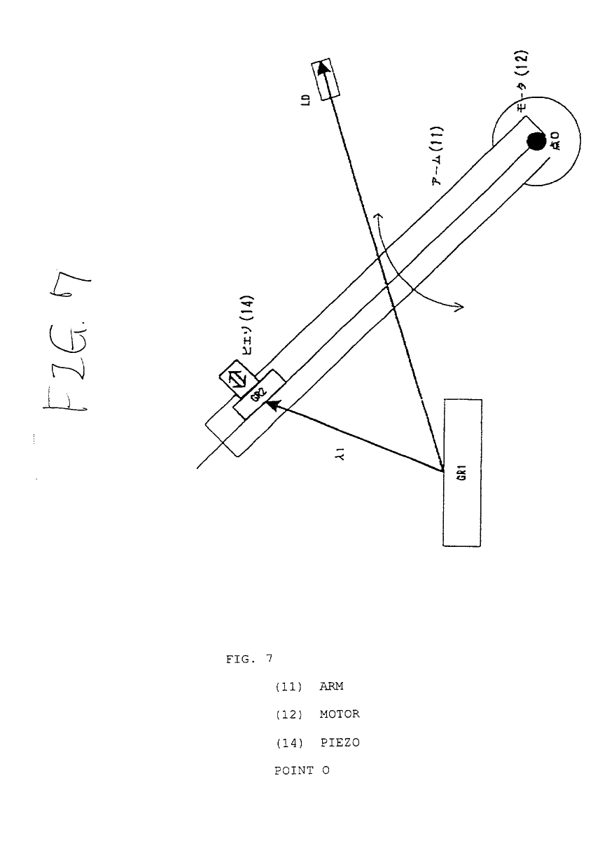

The embodiment of FIG. 7 is set on a differential mechanism moving GR2 to vertical direction to diffraction surface to minimize phase delay quantity as an external resonator.

Control system is a table control of wavelength vs. correction position.

A motor (12) is used for a rotation shaft of an arm (11) of GR 2.

A piezo element (14) is used for a differential mechanism moving GR2 to vertical direction to diffraction surface.

### Fourth Embodiment

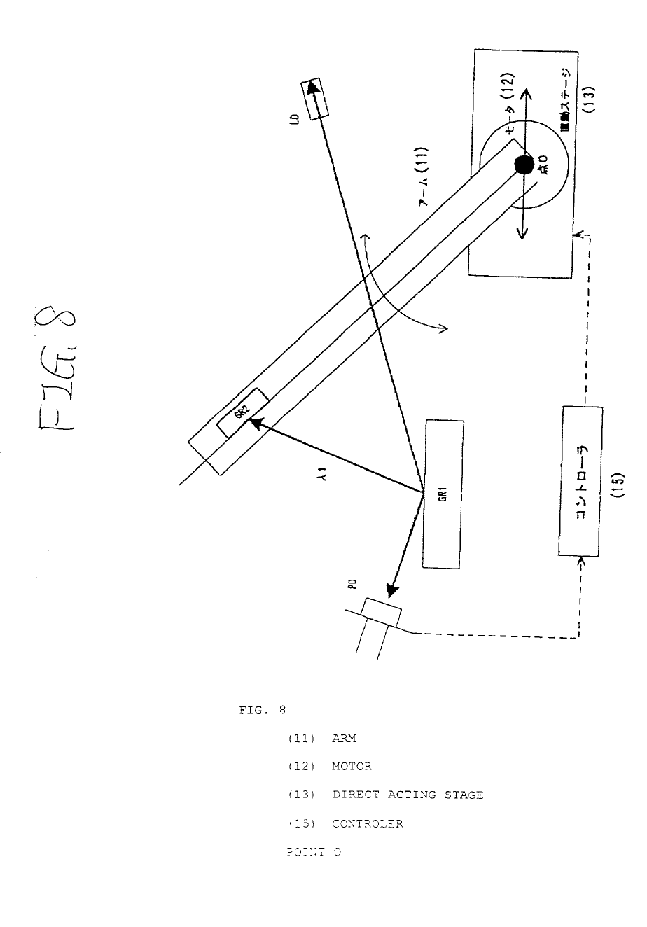

An embodiment of FIG. 8 observes zero order light of oscillation state GR1 in an external resonator with a photo diode PD and controls position of rotation center point so that light output becomes maximum by a control portion (15) in the above-mentioned second embodiment.

Here, in the above-mentioned third embodiment, position of GR2 can be controlled by similar control.

It is possible to insert not only the zero order light of GR1 but another optical element such as a beam splitter and the like into the external resonator. That is, for example, a beam splitter not shown may be placed on the way of λ2.

Although a semiconductor laser is used for laser medium in the above embodiments, the invention is not limited to this, and it is possible to construct an external resonator type laser light source using laser medium except the semiconductor laser.

It is of course possible to change suitably concrete details of the structure and the like.

In the method to make phase delay as the external resonator minimum, it is possible that an optical element changing light path length is arranged in the external resonator so as to adjust external resonator length by electrical or mechanical action except adjusting method of the mechanical external resonator length shown in the second and third embodiments.

As was described above, according to the invention, it is possible to raise filter effect of wavelength and depress unstable oscillation such as multi mode oscillation and mode hop by using the second diffraction grating instead of the mirror.

What is claimed is:

1. An external resonator type laser light source comprising:
a semiconductor laser having reflection reducing coating at one end surface thereof; and
a plurality of diffraction gratings as a wavelength selecting element.

2. An external resonator type laser light source according to claim 1,
wherein outgoing light from the end surface having the reflection reducing coating of the semiconductor laser comes in with diffraction angle α and light having wavelength λ goes out with diffraction angle β at a point A on diffraction surface of a first diffraction grating, the light having wavelength λ going out from the first diffraction grating with diffraction angle β comes in with diffraction angle γ and goes out with diffraction angle γ at a point B on diffraction surface of a second diffraction grating, the light returns to the semiconductor laser passing through opposite direction light path of the second diffraction grating, the first diffraction grating, and the semiconductor laser, and
wherein an end surface of the opposite side to the end surface (1) having reflection reducing coating of the semiconductor laser and the second diffraction grating constructs the external resonator.

3. An external resonator type laser light source according to claim 2,
wherein the point A on diffraction surface of the first diffraction grating, the point B on diffraction surface of the second diffraction grating, and an intersection point C of imagined reflection surface (2′) of the end surface (2) constructing the external resonator of the semiconductor laser assuming that refractive indexes of all components in the external resonator are 1 are positioned on the same circumference of radius r, and an extended line of the imagined reflection surface (2′) and an extended line of diffraction surface of the first diffraction grating cross on the same circumference.

4. An external resonator type laser light source according to claim 2,
wherein laser oscillation is carried out with the same wavelength of diffraction wavelengths of the first diffraction grating and the second diffraction grating by rotating the second diffraction grating at any point O.

5. An external resonator type laser light source according to claim 3;
wherein an intersection point of an extended line of diffraction surface of the second diffraction grating at any wavelength λ1 and an extended line of diffraction surface of the second diffraction grating at another wavelength λ2 in a desired wavelength tuning range is a rotation center point O of the second diffraction grating.

6. An external resonator type laser light source according to claim 5,
wherein phase of laser light in the external resonator is corrected when wavelength changed moving the second diffraction grating round rotation center point O by characteristic that phase delay of laser light within desired wavelength tuning range conflicts with shape of gain distribution of the semiconductor laser based on each numbers of grooves M1 and M2 of the first diffraction grating and the second diffracting grating, incidence angle from the semiconductor laser of the first diffraction grating, the position of rotation center point O, and radius r.

7. An external resonator type laser light source according to claim 5,
wherein a mechanism adjusting the position of rotation center point O of the second diffraction grating is provided.

8. An external resonator type laser light source according to claim 5,
wherein a mechanism adjusting the position of diffraction surface of the second diffraction grating is provided.
